(19) United States
(12) Patent Application Publication
(10) Pub. No.: US 2014/0304469 A1
(43) Pub. Date: Oct. 9, 2014

(54) DATA STORAGE

(71) Applicant: HEWLETT-PACKARD DEVELOPMENT COMPANY, L. P., Houston, TX (US)

(72) Inventor: Chiung-Sheng Wu, The Woodlands, TX (US)

(73) Assignee: Hewlett-Packard Development Company, L. P., Houston, TX (US)

(21) Appl. No.: 13/857,944

(22) Filed: Apr. 5, 2013

(51) Int. Cl. G06F 3/06

(52) U.S. Cl. CPC G06F 3/065; G06F 3/0689; G06F 3/0614
USPC 711/114

(57) ABSTRACT

Storage drives configured as an m-way mirroring disk array with a primary set with a primary portion on each storage drive member in the array and (m−1) mirror sets with mirror portions on each storage drive member in the array to store duplicated data blocks of the primary set, each of the drives to have a primary portion and at least one mirror portion arranged in a stacked configuration. Generate primary write requests to write the data blocks to one or more of the primary portions of the primary set of the plurality of drives, and generate a corresponding mirroring requests to write the duplicated data blocks to corresponding mirror portions of the mirror sets of the drives, wherein, to preserve data redundancy, the primary portion and the corresponding one or more mirror portions with the duplicated data of the primary portion are to reside on different drives.

### BACKGROUND

There are several techniques for managing data storage. For example, data storage can be configured as a Redundant Array of Independent disks (RAID) which comprises an array of multiple independent physical drives that can provide different levels of performance and fault tolerance.

### BRIEF DESCRIPTION OF THE DRAWINGS

Certain examples are described in the following detailed description and in reference to the drawings, in which:

FIG. 1 is an example block diagram of a data storage system in accordance with the techniques of the present application;

FIG. 2 is another example block diagram of a data storage system in accordance with the techniques of the present application;

FIG. 3 is an example process flow diagram of a method of operating a data storage system in accordance with the techniques of the present application;

FIG. 4A through FIG. 4C show example block diagrams of a data storage system in accordance with the techniques of the present application;

FIG. 5A through FIG. 5D show other example block diagrams of data storage systems in accordance with the techniques of the present application; and

FIG. 6 is an example block diagram showing a non-transitory, computer-readable medium that stores instructions for operating a data storage system.

### DETAILED DESCRIPTION OF SPECIFIC EXAMPLES

As explained above, there are several techniques for managing data storage. For example, data storage can be configured as a Redundant Array of Independent disks (RAID) which can comprise an array of multiple independent physical drives that can provide different levels of performance and fault tolerance.

The present application describes techniques that may improve the performance of RAID storage systems. In one example, described is a data storage system that includes a storage controller with a storage management module to configure a disk array of a plurality of storage drives, as an m-way mirroring disk array that comprises a primary set with a primary portion on each storage drive member in the array and (m−1) mirror sets with one or more mirror portions on each storage drive member in the array to store duplicated data blocks of the primary set, wherein the primary portion and the mirror portions are to be arranged in a stacked manner on the storage drives. The storage management module can generate one or more primary write requests to write the data blocks to the primary set comprising primary portions of the plurality of storage drives. The storage management module can generate corresponding one or more mirroring requests to write the duplicated data blocks to one or more corresponding mirror sets comprising mirror portions of the plurality of storage drives, wherein, to preserve data redundancy, the primary portion and the corresponding one or more mirror portions with the duplicated data of the primary portion are to reside on different storage drives.

In this manner, the primary portion and the mirror portion of each storage drive can be arranged in a stacked configuration as part of the same storage drive. Furthermore, the storage system can distribute data across primary portions which can improve performance because data can be read across the primary portions of multiple storage drives. Likewise, the storage system can mirror data in mirror portions of storage drives which can provide data redundancy because the mirror portions can provide identical or duplicate copies of data of the primary portions. The notion of m-way mirroring implies m data sets, including one primary set and (m−1) mirror sets, in the disk array. Each mirror set is configured to store or carry a copy or the duplicated data of the primary set. In the techniques of the present application, all primary and mirror sets distribute data across all member storage drives in the disk array.

The techniques of the present application describe a disk array with a primary set and mirror set(s) in an m-way mirror storage array configuration. An m-way mirror storage array comprises one primary set and (m−1) mirror sets that comprise the exact same or duplicate data blocks in the primary set. For example, in a 2-way mirror storage array, there is one primary set and one mirror set where each set comprises a plurality of storage drives. In another example, in a 3-way mirror storage array, there is one primary set and two mirror sets where each set comprises a plurality of storage drives. That is, an m-way mirror storage array comprises one primary set and (m−1) mirror sets wherein each set comprises a plurality of storage drives. In general, the primary set can be configured with striping across all the storage drives in the array. There is only one primary portion on each storage device. The mirror set(s) can also be configured with striping across all storage drives in the array with proper offsets. With respect to host read requests, the storage management module generates or issues appropriate physical read request(s) to the primary set (with the exception that load-balancing may prefer storage drive access directed to the mirror set(s)). In addition, one or more physical read requests may be generated or issued to serve or respond to a single host read request. Furthermore, the physical read requests may not always need to address the same stripe on the primary set. With respect to host write requests, the storage management module generates or issues appropriate physical write request(s) to the primary set and all mirror sets.

The storage disk array configuration of the present technique provides for reading from the primary set of plurality of storage drives in a manner similar to reading from a conventional RAID-0 (level 0) storage disk array configuration. The mirror set comprises all corresponding mirror portions on each of the member storage drives. For example the first mirror set includes all first mirror portions on each of the storage drives in the array. In this manner, the mirror set can be viewed or operated as a conventional RAID-0 (level 0) configuration with an offset. The primary set comprises a collection of the primary portions on each storage drive in the array. The primary portion configuration can be considered as a striped RAID-0 (level 0) configuration across all storage drive members in the array. Each storage drive can include one primary portion and at least mirror portion arranged in a stacked manner in drive storage space. When storage drives are configured as hard disk drives, the short-stroke enhancement associated with accessing the primary portion in drive storage space may improve serving random read requests. In addition, the primary and the mirror portions on each of the storage drive members in the array are arranged in a stacked manner. The stacked configuration can help improve read performance. Furthermore, these techniques eliminate the total storage drive count constraint of conventional m-way mirror arrays, for example, an even drive count for 2-way mirror RAID configuration and a multiple of 3 drives for 3-way mirror array configurations.

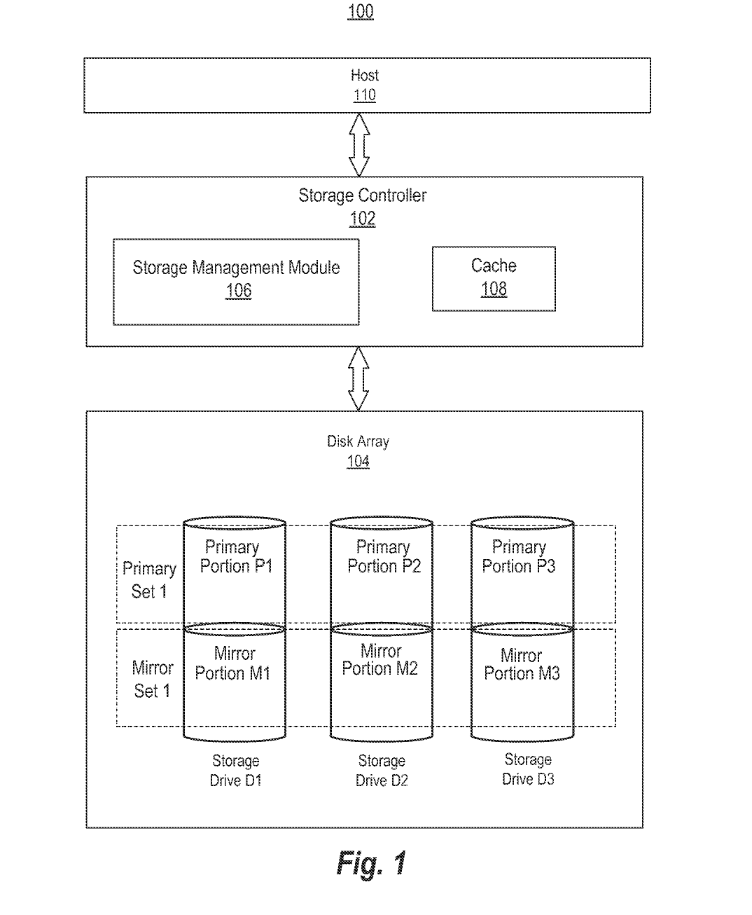

FIG. 1 is an example block diagram of a data storage system 100 in accordance with the techniques of the present application.

The data storage system 100 includes a storage controller 102 coupled to a disk array 104 and a host 110. The storage controller 102 includes a storage management module 106 and can include a cache 108 configured to manage disk array 104. In one example, storage management module 106 can configure disk array 104 of a plurality of storage drives, as an m-way mirroring disk array that comprises a primary set with a primary portion on each storage drive member in the array and (m−1) mirror sets with one or more mirror portions on each storage drive member in the array to store duplicated data blocks of the primary set, wherein the primary portion and the mirror portions are to be arranged in a stacked manner on the storage drives. In the example of FIG. 1, disk array 104 is configured as a 2-way mirroring disk array that includes three storage drives designated as first storage drive D1, second storage drive D2 and third storage drive D3. The disk array 104 comprises a first primary set 1 (indicated by dashed box across primary portions) that includes first primary portion P1, second primary portion P2, third primary portion P3 configured with respective first storage drive D1, second storage drive D2 and third storage drive D3. In addition, disk array 104 includes a first mirror set 1 (indicated by dashed box across mirror portions) that includes a first mirror portion M1, a second mirror portion M2 and a third mirror portion M3 configured with respective first storage drive D1, second storage drive D2 and third storage drive D3. The mirror portions associated with mirror set 1 are configured to store duplicate or identical data blocks of the primary portions of primary set 1. The primary portions and the mirror portions are arranged in a stacked manner on the storage drives. That is, first primary portion P1 resides with first mirror portion M1 on first storage drive D1 in a stacked configuration, second primary portion P2 resides with second mirror portion M2 on second storage drive D2 in a stacked configuration, and third primary portion P3 resides with third mirror portion M3 on third storage drive D3 in a stacked configuration.

The storage management module 106 can be configured to write data blocks to disk array 104. In one example, storage management module 106 can receive from host 110 a request to write data blocks to the disk array. In response to the host request, storage management module 106 can generate one or more primary write requests to write the data blocks to the primary set comprising primary portions of the plurality of storage drives. For example, storage management module 106 can write data blocks to primary portions P1, P2, P3. In addition, storage management module 106 can generate a corresponding one or more mirroring requests to write the duplicated data blocks to one or more corresponding mirror sets comprising mirror portions of the plurality of storage drives, wherein, to preserve data redundancy, the primary portion and the corresponding one or more mirror portions with the duplicated data of the primary portion are to reside on different storage drives. For example, to provide data redundancy, storage management module 106 can store or write duplicate data of primary portion P1 to mirror portion M2 wherein primary portion P1 resides on first storage drive D1 while mirror portion M2 resides on second storage drive D2. Furthermore storage management module 106 can store or write duplicate data of primary portion P2 to mirror portion M3 wherein primary portion P2 resides on second storage drive D2 while mirror portion M3 resides on third storage drive D3. Likewise, storage management module 106 can store or write duplicate data of primary portion P3 to mirror portion M1 wherein primary portion P3 resides on third storage drive D3 while mirror portion M1 resides on first storage drive D1. The storage management module 106 can be configured to buffer, in cache 108, one or more write requests before execution of the write requests. The storage management module 106 can be configured to read data blocks from disk array 104. In one example, storage management module 106 can generate primary read requests to read data blocks from the primary set or, when desired, storage management module may generate mirroring requests to read the data blocks from the mirror sets based on load conditions. For example, storage management module 106 can read from first primary portion P1 of first storage drive D1 or mirror portion M2 of second storage drive D2 which contains duplicate data of primary portion P1. Likewise, storage management module 106 can read from second primary portion P1 of second storage drive D2 or mirror portion M3 of third storage drive D3 which contains duplicate data of primary portion P2. In a similar manner, storage management module 106 can read from third primary portion P3 of third storage drive D3 or mirror portion M1 of first storage drive D1 which contains duplicate data of primary portion P3.

In this manner, the primary portion and the mirror portion of each of the storage drives can be arranged in a stacked configuration as part of the same storage drive. Furthermore, in this manner, the storage system can provide data stripes that extend across storage drives to distribute data across primary portions which can improve performance because data can be read across the primary portions of the storage drives. Likewise, the storage system can mirror data in mirror portions of storage drives which can provide data redundancy because the mirror portions can provide identical or duplicate copies of data of primary portions.

The storage management module 106 can generate write and read requests directed to the storage drives of the disk array based on several factors. As explained below in detail, storage management module 106 may include a mapping mechanism to convert virtual address requests from a host containing Logical Block Address (LBA) referencing data to physical address information to locate or identify data on storage drives on the disk array. For example, storage management module 106 can generate a write request to write data blocks to the storage drives and the write request can specify the starting LBA and the request size specifying the amount of data to write. For example, if the request size covers two data blocks, then those data blocks are contiguous such that are consecutively addressed data blocks. Depending on the starting LEA and the request size, storage management module 106 can automatically generate the necessary physical request(s) to access those two data blocks on the disk array. For example, if those two data blocks reside on the same strip (e.g., the same storage drive), storage management module 106 can issue or generate one request to that particular storage drive in the primary portion. However, if the two data blocks reside across two strips (e.g., two physical storage drives), then storage management module 106 can issue or generate two requests to both storage drives in the primary set. Several factors (such as the starting LBA, the request size, and the array strip, and the total drive count in the array) may determine how many physical requests storage management module 106 may need to issue or generate to fulfill the write request received from or issued by the host/application. In addition, storage management module 106 must issue or generate mirror write requests to write the data blocks to the corresponding storage drives in the mirror set(s).

Furthermore, storage management module 106 can issue or generate write requests based on the configuration of the storage drives of the disk array. The storage management module 106 can issue or generate multiple sets (at least two) of write requests to both the primary and mirror sets substantially in parallel. For example, in a 2-way mirror storage configuration, storage management module 106 can issue or generate one primary write request to write data blocks to the primary set and one mirroring write request to write the data blocks to the mirror set. In another example, for a 3-way mirror storage configuration, storage management module 106 can issue or generate one primary write request to write data blocks to the primary set and issue or generate two mirroring write requests to write the data blocks to the appropriate mirror sets.

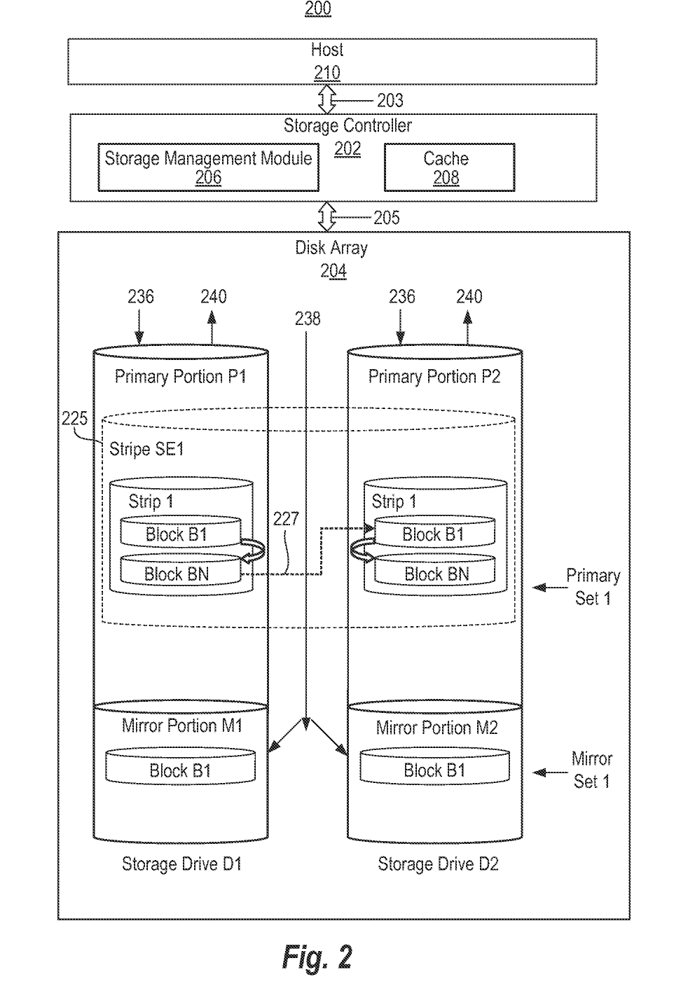

FIG. 2 is another example block diagram of a data storage system 100 in accordance with the techniques of the present application.

The data storage system 200 includes a storage controller 202 coupled to a disk array 204 and a host 210. The storage controller 202 includes a storage management module 206 and a cache 208 configured to manage disk array 204. The system 200 of FIG. 2 is similar to the system 100 of FIG. 1 except for the manner in which disk array 204 is configured as explained below.

In one example, storage management module 206 can configure disk array 204 as a 2-way mirroring disk array that includes two storage drives designated as first storage drive D1 and second storage drive D2. The disk array 204 comprises a primary set 1 that includes first primary portion P1 and second primary portion P2 configured or associated with respective first storage drive D1 and second storage drive D2. In addition, disk array 204 includes a first mirror set 1 that includes a first mirror portion M1 and a second mirror portion M2 configured or associated with respective first storage drive D1 and second storage drive D2. The mirror portions associated with the mirror set are configured to store copies or identical data blocks of the primary portions of the primary set. To preserve data redundancy, the primary portion and the corresponding one or more mirror portions with the duplicated data of the primary portion are to reside on different storage drives. For example, to provide data redundancy, storage management module 206 can store duplicate data of primary portion P1 to mirror portion M2 wherein primary portion P1 resides on first storage drive D1 while mirror portion M2 resides on second storage drive D2. Likewise, storage management module 206 can store duplicate data of primary portion P2 to mirror portion M1 wherein primary portion P2 resides on second storage drive D2 while mirror portion M1 resides on first storage drive D1. The primary portions and the mirror portions are arranged in a stacked manner on the storage drives. That is, first primary portion P1 resides with first mirror portion M1 on first storage drive D1 in a stacked configuration and second primary portion P2 resides with second mirror portion M2 on second storage drive D2 in a stacked configuration.

The first primary portion P1 and the second primary portion P2 can include a data stripe SE1 that extends across first storage drive D1 and second storage drive D2 as shown by dashed boxed area 225. The stripe SE1 can include a strip S1 with blocks B1 through BN to store data blocks wherein each of the storage drives include strips. That is, a stripe may be configured to represent a collection or group of strips from multiple storage devices and each of the strips can include a plurality of blocks to store respective plurality of data blocks. The first mirror portion M1 and the second mirror portion M2 can each include a block B1 to store copies of data blocks of primary portions to provide data redundancy. In this manner, the primary portion and the mirror portion of each storage drive can be arranged in a stacked or stacking configuration as part of the same storage drive. The configuration of disk array 204 shown in FIG. 2 is for illustrative purposes and other examples are possible to employ the techniques of the present application. For example, disk array 204 can include one or more data stripes and each of the primary portions can include one or more strips and each strip can include one or more blocks to store data blocks. Likewise, mirror portions can include one or more blocks to store data blocks.

As explained above, storage management module 206 can configure stripe SE1 to extend across first primary portion P1 and second primary portion P2 of respective first storage drive D1 and second storage drive D2 as shown by dashed boxed area 225. The strip S1 can comprise blocks B1 through BN which can represent the basic unit of storage and the strips can have a size or capacity based on the number of blocks. In one example, to illustrate, the size or capacity of strips can be 64K bytes and hold a total of 128 blocks with each block having a size or capacity of 512 bytes. The storage management module 206 can configure stripe SE1 with strips with addresses that begin at the top of the strips, extend to through and to the bottom of the strips, and extend across strips of the stripe of other storage drives and across further strips and so on. For example, storage management module 206 can configure stripe SE1 to have strip S1 at first storage drive D1 to have addresses that begin at the top of the strip, extend to the bottom of the strip, and extend to another strip across the stripe at second storage drive D2, as shown by dashed arrow 227.

The storage management module 206 may include a mapping mechanism to convert virtual or logical address requests from host 210 containing LBA referencing data to physical address information to locate or identify data on storage drives. The mapping mechanism can use blocks as the basis or minimum amount for addressing calculation purposes. The host 210 can provide virtual or logical addresses of the data blocks to be accessed of virtual storage drive. The storage management module 206 can then convert the virtual or logical addresses to physical addresses. In one example, storage management module 206 can calculate the corresponding physical address based on the number of storage drives and number of data stripes of primary portions of disk array 204. In one example, to illustrate, it can be assumed that storage management module 206 configures disk array 204 to have first storage drive D1 and second storage drive D2 with a stripe SE1 that extends across respective first primary portion P1 and second primary portion P2 as shown by dashed boxed area 225. In this case, first primary portion P1 and second primary portion P2 can each have a strip S1 with a size or capacity of 64K bytes. Further in this case, each of the strips S1 can hold a total of 128 blocks and with each block having a size or capacity 512 bytes. In this case, storage management module 206 can configure strip S1 of first storage drive D1 to have addresses that begin at the top of the strip, extend to the bottom of the strip, and extend across the strip at second storage drive D2, as shown by dashed arrow 227.

Therefore, storage management module 206 can convert virtual or logical address space to physical address space by identifying the location of the stripe which contains the requested data block. The process can include dividing the virtual or logical address by the total strip size, in this case a total of 128K bytes (which is the sum of strip size of 64K bytes of first storage drive D1 and strip size of 64K bytes of second storage drive D2). Once storage management module 206 determines the location of the corresponding stripe that contains the requested block, then it can use the reminder amount to determine the particular corresponding storage drive and block of the location of the requested data block.

In one example, as shown in FIG. 2, storage management module 206 can configure disk array 204 to have primary portions P1, P2 located at the beginning or top of the address space of the storage drive followed by mirror portions M1, M2. In another example, storage management module 206 can configure disk array 204 to have mirror portions M1, M2 located at the beginning or top of the address space of the storage drive followed by primary portions P1, P2. The storage size or capacity of primary portions P1, P2 and mirror portions M2, M2 may be configured or sized to fit the storage capacity of a particular storage device. For example, first primary portion P1 may be configured to store 50% of the total capacity of a particular storage drive and first mirror portion M1 may be configured to store the remaining 50% of the total capacity of the storage drive. However, it should be understood that other capacity configurations can be employed to practice the techniques of the present application. In the above example, it is assumed that the mirror portion represents 50% of the total capacity in the context of a 2-way mirror configuration, such as a RAID-1 (level 1) or RAID (1+0) configuration. However, it should be understood that other examples are possible, in more general configurations, the primary portion may be part of an m-way mirror storage configuration and the capacity would be limited to up to 1/m capacity.

In one example, storage management module 206 can receive requests from host 210 to write data blocks to disk array 204. For example, storage management module 206 can receive from host 210 a request to write a plurality of consecutively addressed data blocks. To illustrate, it can be assumed that the data blocks are to be stored or written across stripe SE1 that extends across first primary portion P1 and second primary portion P2. The storage management module 206 can respond with generation of a primary write request (arrow 236) to write data blocks to strip S1 of stripe SE1 of first primary portion P1 of first storage drive D1 and then another primary write request to write data blocks to strip S1 of second primary portion P2 of second storage drive D2. That is, storage management module 206 generates two physical write requests to write data blocks to both first storage drive D1 and second storage drive D2. The storage management module 206 can further respond with a mirroring write request (arrow 238) to write the data blocks from primary portion P2 to the mirror portion M1 of first storage drive D1 and another mirroring write request to write the data blocks from primary portion P1 to the mirror portion M2 of second storage drive D2. In this manner, the storage system can stripe or distribute data across data stripes of primary portions of storage drives which can help improve performance because data can be read across the primary portions of multiple storage drives. Likewise, the storage system can mirror data in mirror portions of storage drives which can provide or preserve data redundancy because the mirror portions provide copies or identical data of primary portions.

In another example, storage management module 206 can receive requests from host 210 to read data blocks from disk array 204 and to forward or send the data blocks back to the host. For example, storage management module 206 can receive from host 210 a request to read a plurality of consecutively addressed data blocks. To illustrate, it can be assumed that the data blocks are read from stripe SE1 that extends across first primary portion P1 of first storage drive D1 and second primary portion P2 of second storage drive D2. The storage management module 206 can respond with generation of a primary read request (arrow 240) to read data blocks that extend across stripe SE1 by reading data blocks from strip S1 of first primary portion P1 of first storage drive D1 and another primary read request to read data blocks from strip S1 of second primary portion P2 of second storage drive D2. That is, storage management module 206 generates two physical read requests to read data blocks from both first storage drive D1 and second storage drive D2. As explained above, in this manner, the storage system can stripe data across data stripes that extend across primary portions of storage drives which can improve performance because data can be read across the data stripes of the primary portions of the storage drives.

In one example, storage management module 206 can present disk array 204 as virtual storage or space to host 210 or other applications or devices. The storage management module 206 can group blocks to be combined to represent extents. The storage management module 206 can use extents to provide a means of generating virtual storage or disk drives by combining parts of member storage drive or disk block address spaces. The storage management module 206 can include a mapping mechanism to establish a relationship or association between member storage drive or disk data addresses and virtual storage or disk addresses. The storage management module 206 can divide each of the extents into a number of identically sized strips of consecutively addressed blocks. The storage management module 206 can present storage drives of disk array 204 to the host as one or more virtual storage drives or disks by converting Input/Output (I/O) requests directed to the virtual storage to I/O requests to physical storage drives. For example, from the perspective of host 210, storage management module 206 can present the plurality of storage drives, in this case storage drives D1, D2 as one virtual storage drive or space to the host. As explained above, primary portions P1, P2 can be configured as a disk array with a stripe SE1 extending across multiple storage drives D1, D2 in which stripping or distributing data across the storage drives can effectively provide a large virtual storage drive or space to host.

As explained above, storage management module 206 may include a mapping mechanism to convert requests from host 210 containing LBA referencing data to physical address information to locate data on storage drives. For example, in the case that storage drives are implemented as Hard Disk Drives (HDDs) with sectors, the LBA mapping mechanism may provide a means to identify sectors in the HDDs. In the HDD example, the first sector on the disk drive, which is referred to the Master Boot Record (MBR), is numbered 0 and the following sectors are numbered sequentially. In other words, the LBA address mechanism provides a sector number where the count starts at 0 and, for example, sector 10 represents sector 11 on the disk drive. Through the use of the LBA mapping mechanism of a virtual storage drive of the host and disk drive array count, the mapping mechanism can locate the particular storage drive and associated LBA (to the member storage drive) associated with the LBA.

In another example, assume that host 210 includes a virtual storage drive or space with a sequence of data blocks stored in blocks of strips represented as Strip1, Strip2 and Strip3. In this case, to illustrate, disk array 204 can be configured to include three storage drives with a stripe extending across the storage drives with the data blocks stripped or distributed across the three storage drives. In this case, Strip1 can be stored on primary portion of the first storage drive, Strip2 can be stored on the primary portion of the second storage drive, and Strip3 Can be stored on primary portion of the third storage drive. In one example, host 110 can generate requests to access virtual storage data represented by Strip1, Strip2, and Strip3 which is received and translated by storage management module 206 into physical address information to access respective Strip1, Strip2, and Strip3 on respective storage drives of disk array 204. However, it should be understood that this example is for illustrative purposes and that other examples are possible to illustrate the techniques of the present application.

In one example, storage management module 206 can be configured to respond to storage array degradation conditions. For example, degradation conditions can include when one or more storage devices of disk array 204 fail such that data from the failed storage drives can no longer be accessed or retrieved wherein the storage array to operate in a degrade mode. In other words, storage drives fail while storage arrays degrade. That is, a storage array may cease to serve or respond to host requests if the storage array fails. The storage array may fail if a few storage drives fail simultaneously and at least one primary portion and all its corresponding mirror portions cannot be accessed. In one example, the mirror RAID configuration of the present application may survive or be accessible with one or more storage drive failures in the mirror array as long as for every primary portion in the primary set at least the primary or one of the corresponding mirror portions survives or is accessible. This can be attributed to the built-in redundancy arrangement of the storage configuration of the techniques of the present application in which the entire virtual storage space can remains in intact even though the storage management module can no longer access the failed drive(s). For example, in response to a request to read data blocks from a primary portion of a failed storage drive, storage management module 206 can generate a request to read data blocks from a mirror portion of another storage drive that contain the data blocks of the primary portion of the failed storage drive. In another example, in response to a storage array degradation condition, storage management module 206 can initiate a rebuild process that includes a request to copy a mirror portion of another storage drive that contains data blocks of the primary portion of the failed storage drive to a primary portion of a replacement storage drive. As part of the rebuild process, storage management module 206 can further generate requests to copy the primary portion of the other storage drive that contain data blocks of a mirror portion of the failed storage drive to a mirror portion of the replacement storage drive. In this manner, storage system provides mirror data in mirror portions of storage drives to provide redundancy because the mirror portions can provide identical copies of data of primary portions and allow the storage system to continue to operate and access data from disk array 204.

The storage management module 206 can include an optional write cache 208 to store or buffer write requests directed to disk array 204. In one example, storage management module 206 can configure cache 208 as a write back cache and can group write requests by providing a process to schedule write back of the write requests, one mirroring set (primary and mirror portions) at a time. The storage management module 206 can buffer in cache 208 one or more write requests before execution of the write-back requests. The cache 208 can include any means of storing data such as non-volatile memory, volatile memory, and/or one or more storage devices, and the like. For example, cache 208 can be configured to be battery or flash-back protected to preserve contents of the cache in case of power loss.

As explained above, storage management module 206 can be configured to generate requests to write data blocks to disk array 204 in response to host requests to write data blocks. In one example, storage management 206 can be configured to generate write requests such that data blocks on both the primary portions and the mirror portions are updated to preserve data consistency between the primary and mirror portions. In one example, when storage drives are configured as HDDs and when both primary portions and mirror portions reside on the same disk drive are to be updated, the disk drive heads may need to move across (e.g., fly over) the disk platter (e.g., the half of the disk tracks). In the HDD example, seek latency or seek time may be defined as the amount of time it takes for the disk drive head assembly on an actuator arm to travel to the track of the disk drive where the data will be read or written.

As explained above, storage management module 206 can be configured to operate cache 208. The storage management module 206 may configure cache 208 to help reduce or minimize the seek latency by implementing or adopting a two-stage write-back process. In the first stage of the process, storage management module 206 can buffer write requests in cache 208 and then write-back the cached write requests to the primary set of disk array 204. In this manner, this process may be similar to the write process to write data blocks to a RAID-0 (level 0) configured disk array. The storage management module 206 can then track or mark the cached write requests that have successfully completed the first stage of the process. In the second stage of the process, storage management module 206 can generate write requests to write-back the cached write requests from cache 208 that have completed the first stage process to the mirror set of disk array 204. The storage management module 206 can then mark the cached write request as “cleaned” after it has successfully written back the write requests to both the primary and mirror sets of disk array. In an example, with random write requests, the above two-stage write-back process can help reduce or eliminate undesired fly-over seek latency that storage drives may encounter. In addition, in the above two-stage process, for each write-back stage, random accesses may also take the advantages of quasi-short stroking effects which may be encountered when storage drives are implemented as HDDs. The notion of short stroking is a term that is used in an enterprise storage environment that describes a HDD that is purposely restricted in total capacity so that the disk drive actuator only has to move the heads across a smaller number of total tracks. The above two-stage write-back process is described in the context of a 2-way mirror RAID configuration. In another example, for an m-way mirror RAID configuration, the write-back process may be implemented as an m-stage write-back process.

As explained above, storage management module 206 can be configured to generate requests to read data blocks from disk array 204 in response to host requests to read data blocks. In one example, storage management module 206 can generate read requests to read data blocks from the primary set or the mirror sets of disk array 204. In some cases, it may be desirable for storage management module 206 to generate read requests directed to the primary portions of storage drives. In one example, storage management module 206 may generate sequential read requests to access consecutively addressed data blocks from storage drives. In this case, the read performance of disk array may be similar to the read performance of a conventional RAID-0 (level 0) configured disk array. In another example, storage management module 206 may generate random read requests to access random or non-consecutively addressed data blocks from storage drives. In this case, directing random read requests to the primary portions of storage drives can help confine disk drive accesses to the top portion of the disk drives which can reduce disk drive seek latency, particularly related to short stroking disk drive configurations. In the case of true random write and read requests, the disk drive accesses are expected to be fairly uniform among all member disk drives in the array. In general, load balance (such as from disk drive accesses to the disk drives in the disk array) can be generally automatically maintained. In another example, storage management module 206 may divert or redirect some physical disk drive requests to the corresponding mirror portions to help maintain fair load balancing among drive members in the array.

The host 210 can include any data processing device configured to process data and communicate with other devices such as storage controller 202. For example, host 210 can include any data processing device such as a server computer, client computer and the like. In one example, host 210 can include applications to communicate with devices to manage file systems comprising blocks and send requests to storage controller 202 to store or write data blocks to disk array 204 and requests to read or retrieve data blocks from the disk array. The storage controller 202 can include any data processing device configured to process data and communicate with other devices such as host 210. For example, storage controller 202 can include any data processing device such as a server computer, client computer and the like. The storage controller 202 and associated components such as storage management module 206 and cache 208 can be implemented in software, hardware or a combination thereof.

The host 210 is shown communicatively coupled to storage controller 202 through communication channel 203 and the storage controller is shown communicatively coupled to disk array 204 through communication channel 205. The communication channels 203, 205 can include any communications means, interfaces, protocols such as Fibre Channel, Ethernet, Wireless, Wired, optical, Small Computer System Interface (SCSI), Serial Attached SCSI (SAS), Advanced Technology Attachment (ATA), Serial Advanced Technology Attachment (SATA) and the like. It should be understood that system 200 of FIG. 2 is shown for illustrative purposes and other examples are possible to employ the techniques of the present application. For example, system 200 can include one or more hosts 210 communicatively coupled to one or more storage controllers 202 and the storage controllers can be communicatively coupled to one or more disk arrays 204. The storage drives can include any means of storing data for subsequent retrieval. For example, the storage drives can include any storage technology such as HDD, Solid State Drive (SSD), flash drives or combinations thereof.

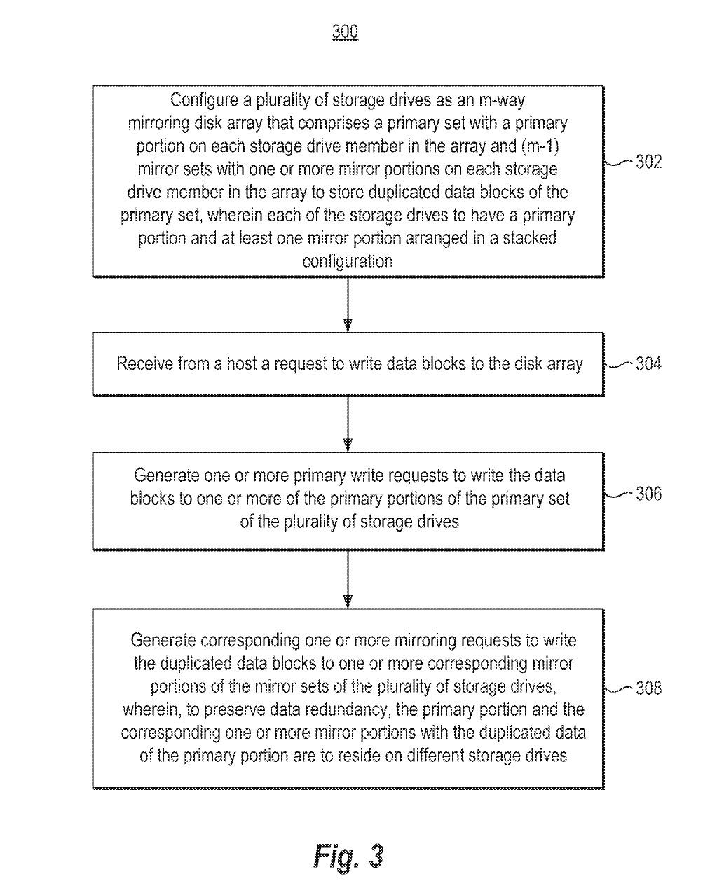

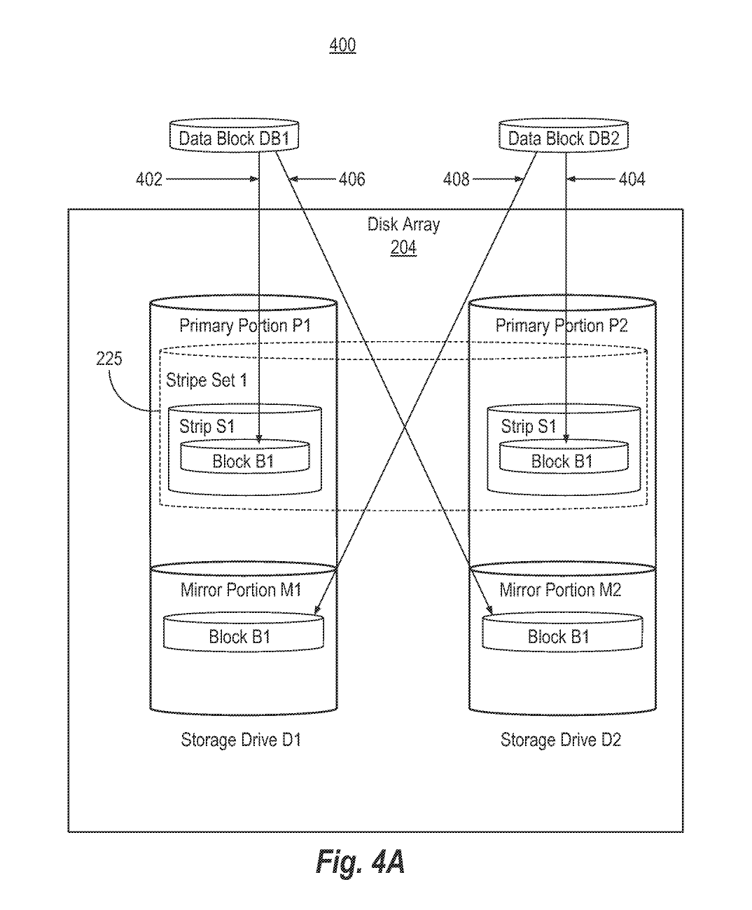

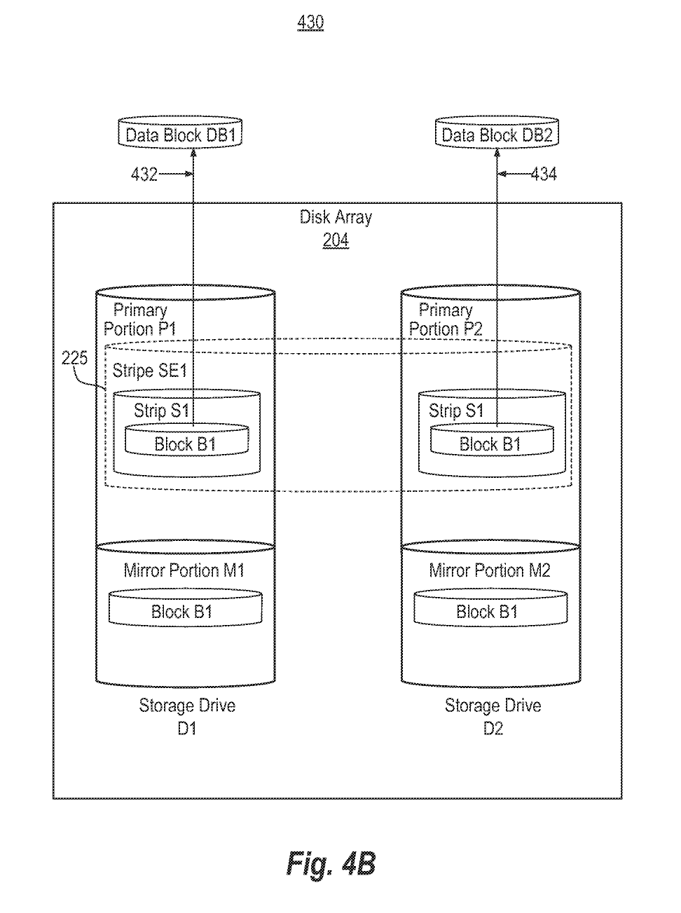

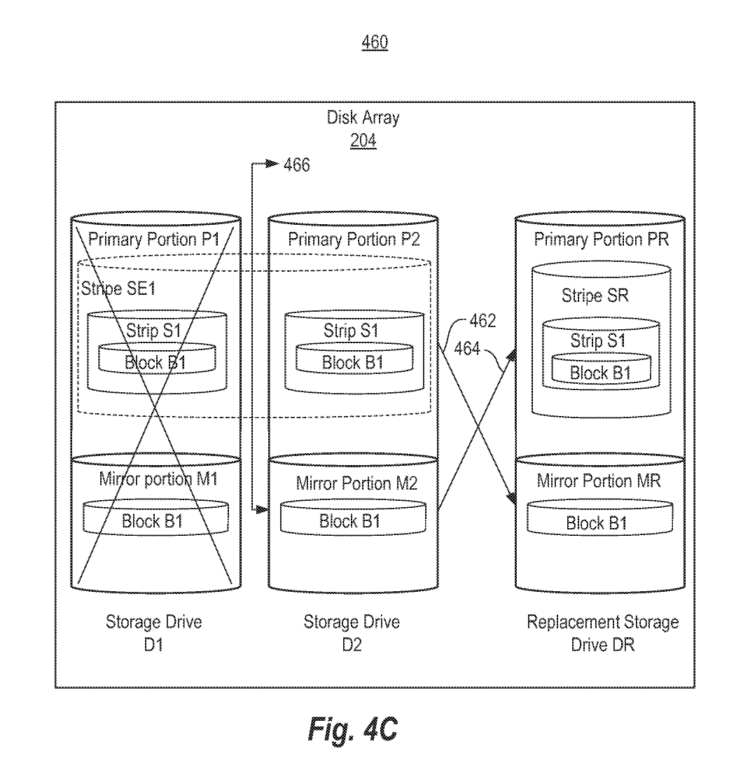

FIG. 3 is an example process flow diagram 300 of a method of operating a data storage system in accordance with the techniques of the present application. To illustrate, in one example, it can be assumed that data storage system 200 of FIG. 2 includes storage controller 202 coupled to host 210 and disk array 204 in which storage management module 206 is configured to manage the operation of the disk array according to the techniques of the present application. In one example, FIG. 4A shows a block diagram 400 of a process for generating write requests to write data blocks to disk array, FIG. 4B shows a block diagram 430 of a process for generating read requests to read data blocks from disk array, and FIG. 4C shows a block diagram 460 of a process for responding to a storage array degradation condition in accordance with the techniques of the present application.

The method may begin at block 302, where storage controller 202 configures an m-way mirroring disk array that comprises a primary set with a primary portion on each storage drive member in the array and (m−1) mirror sets with one or more mirror portions on each storage drive member in the array to store duplicated data blocks of the primary set, wherein the primary portion and the mirror portions are to be arranged in a stacked manner on the storage drives. In one example of FIG. 4A, disk array 204 is configured as a 2-way mirroring disk array that includes two storage drives designated as first storage drive D1 and second storage drive D2. The disk array 204 comprises a primary set that includes a first primary portion P1 and a second primary portion P2 configured with respective first storage drive D2 and second storage drive D2. In addition, disk array 204 includes a first mirror set with a first mirror portion M1 and a second mirror portion M2 configured with respective first storage drive D1 and second storage drive D2. The mirror portions associated with the mirror set are configured to store duplicated data blocks of the primary portions of the primary set. The primary portions and the mirror portions are arranged in a stacked manner on the storage drives. That is, first primary portion P1 resides with first mirror portion M1 on first storage drive D1 in a stacked configuration and second primary portion P2 resides with second mirror portion M2 on second storage drive D2 in a stacked configuration. The first primary portion P1 and the second primary portion P2 can include a data stripe SE1 that extends across first storage drive D1 and second storage drive D2 as shown by dashed boxed areas 225. The stripe SE1 includes a strip S1 with a block B1 on each of the storage drives to store data blocks. In general, there can be a plurality of blocks associated with each strip and a data stripe can include a collection of data stripes from all of the storage drives of the array.

At block 304, storage controller 202 receives from host 210 a request to write data blocks to disk array 204. As explained above, host 210 may send to storage controller 202 requests for data blocks of virtual storage and storage management 206 may receive and translate these logical requests into requests with address information of the locations of the data blocks on corresponding storage drives on disk array. In one example, to illustrate operation, referring to FIG. 4A, storage management module 206 may receive a request to write a first data block DB1 and a second data block DB2 which are consecutively addressed data blocks. The storage management module 206 may use an LBA mapping mechanism to translate this host request to determine to write first data block DB1 to block B1 of first primary portion P1 of first storage drive D1 and write the first data block DB1 to block B1 of second mirror portion M2 of second storage drive D2. In addition, storage management module 206 may determine to write second data block DB2 to block B1 of second primary portion P2 of second storage drive D2 and write second data block DB2 to block B1 of first mirror portion M1 of first storage drive D1, as explained below.

At block 306, storage controller 202, in response to the host request, generates one or more primary write requests to write the data blocks to one or more of the primary portions of the primary set of the plurality of storage drives. In one example, to illustrate operation, referring to FIG. 4A, storage management module 206 generates a primary write request (arrow 402) to write first data block DB1 to block B1 of first primary portion P1 of first storage drive D1. In a similar manner, to illustrate operation, storage management module 206 can generate another primary write request (arrow 404) to write second data block DB2 to block B1 of second primary portion P2 of second storage drive D2. That is, storage management module 206 generates two physical write requests to write the data blocks to both first storage drive D1 and second storage drive D2. As explained above, host 210 may send to storage controller 202 requests for data blocks of virtual storage and storage management 206 may receive and translate these virtual requests into requests with address information of the locations of the data blocks on corresponding storage drives on disk array.

At block 308, storage controller 202 generates corresponding one or more mirroring requests to write the duplicated data blocks to one or more corresponding mirror portions of the mirror sets of the plurality of storage drives, wherein, to preserve data redundancy, the primary portion and the corresponding one or more mirror portions with the duplicated data of the primary portion are to reside on different storage drives. In one example, to illustrate operation, referring to FIG. 4A, storage management module 206 generates a mirroring write request (arrow 406) to write first data block DB1 to block B1 of second mirror portion M2 of second storage drive D2. In a similar manner, in one example, to illustrate operation, storage management module 206 generates another mirroring write request (arrow 408) to write second data block DB2 to block B1 of first mirror portion M1 of first storage drive D1. That is, storage management module 206 generates two physical read requests to write the data blocks to both first storage drive D1 and second storage drive D2. In this case, to preserve data redundancy, the primary portion and the corresponding one or more mirror portions with the duplicated data of the primary portion reside on different storage drives. For example, to provide data redundancy, storage management module 206 stores duplicate data of primary portion P1 to mirror portion M2 wherein primary portion P1 resides on first storage drive D1 while mirror portion M2 resides on second storage drive D2.

In the above process, in this manner, storage management module 206 configures disk array 204 to have a data stripe extending across multiple storage drives to strip or distribute data blocks across multiple storage drives. In this case, data stripe SE1 extends across first storage drive D1 and second storage drive D2 to allow first data block DB1 to be stored on primary portion P1 of first storage drive D1 and second data block DB2 to be stored on primary portion P2 of second storage drive D2. This striped array configuration may provide for improved performance in terms of reading data and writing data. In addition, storage management module 206 can configure data blocks in a mirrored manner, for example, in this case, first data block DB1 is written or mirrored to mirror portion M2 of second storage drive D2 and second data block DB2 is written or mirrored to mirror portion M1 of first storage drive D1. This mirrored array configuration may provide for data redundancy because the mirrored can provide accessible data when the array operated in the degraded mode (e.g., one or more storage drives fail) and can also be used to rebuild the degraded array when the failed drive is replaced. It should be understood that FIG. 4A is for illustrative purposes and that other configurations are possible to implement the techniques of the present application. For example, storage management module 206 can receive a request to write or read more than two data blocks DB1, DB2 and can store more than one data block in primary portion and mirror portion of each storage drive.

In another example, the storage system may experience some undesired latencies with write requests (for example, in storage disks such as HDDs) as write requests are served back and forth from stacking spaces (from all mirror sets or mirror portions) within each storage drive. However, storage management module 206 may reduce such undesired latencies by buffering write requests first in cache 208. The storage management module 206 can configure cache 208 as a write-back cache and group the write requests and schedule write-back of the write requests one mirror set at a time. In one example, these techniques may take into consideration storage drive or disk drive quasi short-stroke action and reduce the need of long flying-over access jumping between primary/mirror portions in each storage drive and thereby reduce write penalty. In another example, for each storage controller 202 generated write request to a mirrored set (mirrored portion), the storage controller can generate one or more requests to its storage drive or disk members depending on its request size. For each storage drive or disk access, the write request to the strip of interest of a storage drive may involve a partial strip or a full strip. The storage controller 202 may include a mapping mechanism configured to automatically determine the proper storage drive or disk LBA and request sizes when it generates write requests to the storage drive or disk members in the disk array.

FIG. 4B shows an example block diagram 430 of a process of generating read requests to read data blocks from disk array in accordance with the techniques of the present application. In one example, storage controller 202 may receive from host 210 a request to read a plurality of consecutively addressed data blocks that includes a first data block DB1 and a second data block DB2. The storage management module 206 may receive these host requests for data blocks of virtual storage and translate these virtual or logical requests into requests with address information of the locations of the data blocks on corresponding storage drives on disk array. In one example, storage management module 206 may receive a request to read first data block DB1 and second data block DB2 which are consecutively addressed data blocks. The storage management module 206 may use an LBA mapping mechanism to translate this host request to determine that the location of first data block DB1 is at block B1 of first primary portion P1 of first storage drive D1 and that the location of second data block DB2 is at second primary portion P2 of second storage drive D2.

Continuing with the above example, to illustrate operation, to read first data block DB1, storage management module 206 may generate a primary read request (arrow 432) to read first data block DB1 from block B1 of first primary portion P1 of first storage drive D1. In another example, it may be desirable to read first data block DB1 from the mirror portion instead of the primary portion. That is, Instead of reading from first storage drive D1, in another example, if storage management module 206 determines that the first storage drive is experiencing a heavy load from large amounts of storage access activity, the storage management module may generate a mirroring read request to read first data block DB1 from block B1 of mirror portion M2 of second storage drive D2. Next, to read second data block DB2, to illustrate operation, storage management module 206 may generate another primary read request (arrow 434) to read second data block DB2 from block B1 of second primary portion P2 of second storage drive D2. That is, storage management module 206 generates two physical read requests to read the data blocks from both first storage drive D1 and second storage drive D2. Like the example above, it may be desirable read second storage block DB2 from the mirror portion instead of the primary portion. That is, instead of reading from second storage drive D2, if storage management module 206 determines that the second storage drive is experiencing a heavy load from large amounts of storage access activity, the storage management module may generate a mirroring read request to read second data block DB2 from block B1 of first mirror portion M1 of first storage drive D1.

In one example, the above process of the techniques of the present application can apply to an m-way mirror RAID based configuration in which the mirror sets can include the same (mirror copy) or exact duplicated data of primary portions. The storage controller 202 can be configured to read from each mirror set to fulfill read requests. In one example, storage controller 202 can read data from the primary mirror set. In this case, since the primary mirror set is configured as RAID-0 (level 0) configuration stripping across all storage drives in the array, reading data from the proposed disk array is similar to reading data from a conventional RAID-0 disk array configuration.

In another example, for input read requests from host 210, storage controller 202 may generate one or more read requests directed to its storage drive members (of the primary set, for example) depending on its request size. For example, for each storage drive access request, a read request to the corresponding strip may involve a partial strip or a full strip. The storage management module 206 may include a mapping mechanism to automatically determine the proper storage drive or disk LBA and request sizes when it generates read request(s) to the storage drive or disk members in the disk array. It should be understood that FIG. 4B is for illustrative purposes and that other configurations are possible to implement the techniques of the present application. For example, storage management module 206 can receive a request for more than two data blocks DB1, DB2 and can read more than one data block in primary portion and mirror portion of each storage drive.

FIG. 4C shows an example block diagram 460 of a process of responding to array degradation conditions in accordance with the techniques of the present application. In one example, to illustrate operation, storage management module 206 can detect a storage drive failure condition in first storage drive D1 such that the storage management module may no longer be able to access data blocks from the first storage drive (shown by cross hatch drawn across first storage drive D1). That is, individual storage drive failures indicate disk array degradation. In response to a read request to read from first storage drive D1, storage management module 206 may respond with a mirroring read request (arrow 466) to disk array 204 to read the stored data blocks of second mirror portion M2 of second storage drive D2 because the mirror portion M2 contains a copy of the data blocks of first primary portion P1 of first storage drive D1 which is no longer accessible because of the storage drive failure. In this manner, storage management module 206 can provide fault tolerance through redundant data stored on mirrored portions to allow the system to continue storage access operations such as to read data from disk array and to write data to disk array.

In another example, to illustrate operation, storage management module 206 can detect a storage drive failure condition in first storage drive D1 such that the storage management module may no longer be able to access data blocks from the first storage drive (shown by cross hatch drawn across first storage drive D1). In addition, storage management module 206 can detect a newly inserted storage drive or directly assign a readily online spare drive as the replacement drive and respond with initiation of a rebuild process. In another example, storage management module 206 can determine that it can recover the data from the failed storage drive D1 and initiate a rebuild process that can include copying the data from second storage drive D2 to a replacement storage drive DR. For example, storage management module 206 can generate requests (arrow 462) to disk array 204 to initiate a copy of the stored data blocks of second primary portion P2 of second storage drive D2 to mirror portion MR of replacement storage drive DR. In addition, storage management module 206 can generate requests (arrow 464) to disk array 204 to copy stored data blocks from mirror portion M2 of second storage drive D2 to primary portion PR of replacement storage drive DR. In this manner, storage management module 206 can restore or rebuild the data from the failed storage to the replacement storage drive and allow the system to continue storage access operations such as to read data from disk array and to write data to disk array.

In another example, storage management module 206 may configure disk array 204 to be similar to mirrored array arrangements, such as a RAID-1 (level 1) configuration or RAID(1+0) configuration, and to sustain one or more storage or disk drive failures as long as not all storage drives that contain the same mirrored data fail simultaneously. Once storage management module 206 detects or senses array degradation or storage drive failures, the storage management module can re-direct access requests, such as read requests, to the surviving or non-failed storage drives with the corresponding mirrored data. For example, to illustrate, in a dual storage drive or disk configuration, if first storage drive D1 containing primary portion P1 encounters a storage drive failure condition, storage controller 202 can re-direct intended read requests from primary portion P1 to second storage drive D2 containing mirror portion M2 which contains a copy of duplicate data of primary portion P1. The storage controller 202 can include a mapping mechanism to automatically adjust the storage drive or disk LBA for the re-directed read requests. For input or incoming write requests from host 210, storage controller 202 can continue the same write process with the exception that the storage controller no longer needs to generate any write requests to the failed storage drive.

In another example, when a failed storage drive (encounters a storage failure condition) is replaced in a conventional RAID-1 (level 1) mirror configuration, a storage controller can initiate a copy of the contents of its mirror storage drive to a replacement storage drive or disk. In one example, storage management module 206 can execute a rebuild process similar to the process in a RAID-1 (level 1) configuration or RAID(1+0) configuration except, in the techniques of the present application, each storage drive member can include both primary data (striped) and mirror data. The storage controller 202 can determine the locations of the surviving mirror sets (portions) and copy the contents to the newly replacement storage drive(s). For example, assume a dual storage drive configuration with a first storage drive D1 (with a primary portion P1 and a mirror portion M1) that failed and second storage drive D2 (with primary portion P2 and mirror portion M2) and a new storage drive is replaced. The storage controller 202 can then copy mirror portion M2 from storage drive D2 to new primary P1 in the replacement storage drive and complete the same copy process for primary P2 to the new mirror portion M2 of the replacement storage drive. The copy process can be performed in a sequential manner (one or more strips at a time). However, it should be understood that the storage controller can perform the copy process according to other configurations or arrangements. The storage controller 202 can be configured to verify that all data or information will be copied to the replacement storage data and that data consistency is maintained among all mirror sets (mirror portions).

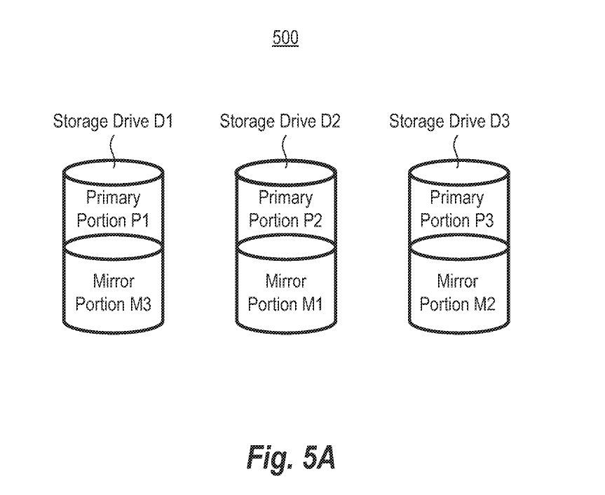

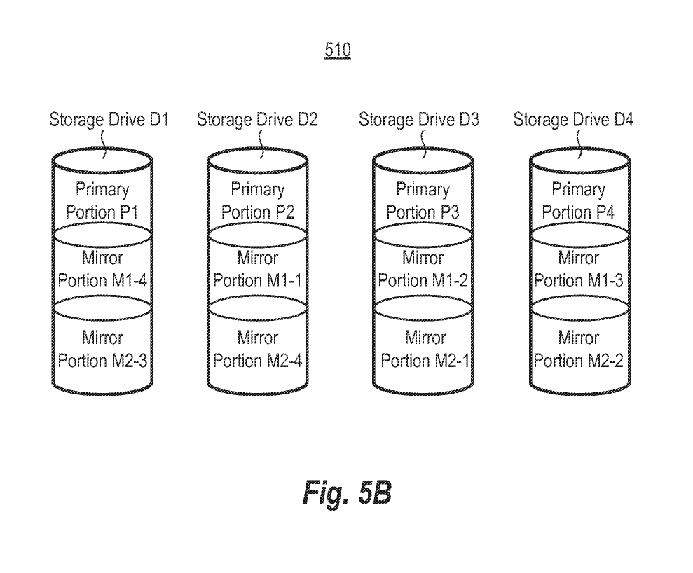

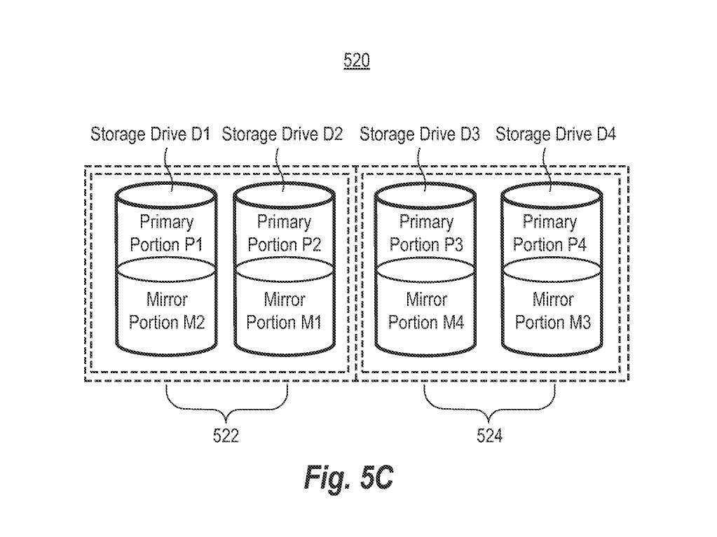

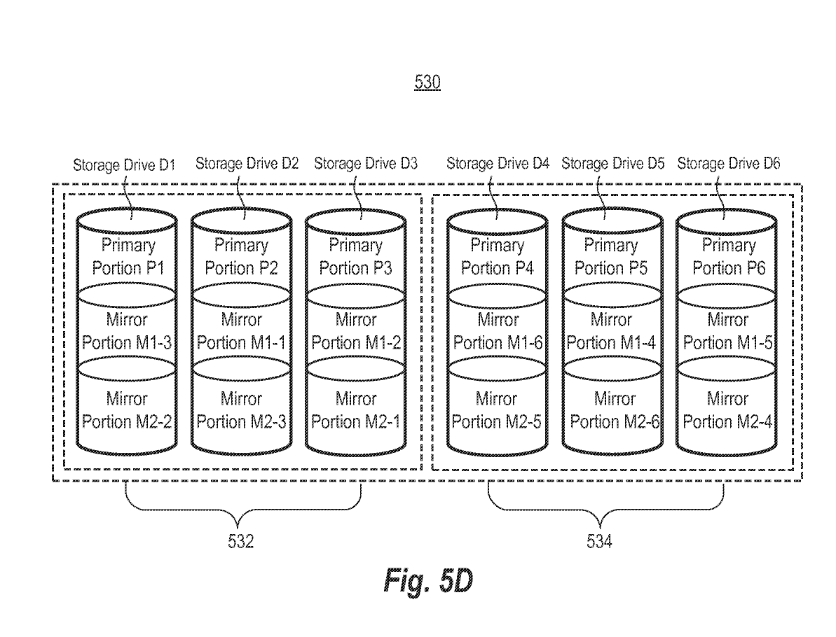

FIGS. 5A through 5D show example block diagrams of data storage systems in accordance with the techniques of the present application.

FIG. 5A shows an example block diagram of a data storage system 500 in accordance with the techniques of the present application. In one example, to illustrate, system 500 includes a 2-way mirroring disk array comprising three storage drives: first storage drive D1, second storage drive D2 and third storage drive D3. The first storage drive D1 is configured to include a primary portion P1 and a mirror portion M3. The second storage drive D2 is configured to include a primary portion P2 and a mirror portion M1. The third storage drive D3 is configured to include a primary portion P3 and a mirror portion M2. In one example, the primary portions can part of primary set and be configured as a striped array with corresponding mirror portions configured as a mirrored array as part of a mirror set. That is, the primary portions can include data stripes extending across the storage drives with each storage drive including strips extending across the data stripe to store data blocks. In one example, the primary portions can be designated as P1 through PN where N represents storage drives, and in this case P1 through P3 where N=3. Likewise, the mirror portions are designated as M1 through MN where N represents storage drives, and in this case M1 through M3 where N=3.

In one example, mirror portion M3 of first storage drive D1 can be configured to store a copy or duplicate of the data blocks from primary portion P3 of the third storage drive D3. In a similar manner, mirror portion M1 of second storage drive D2 is configured to store a copy or duplicate of the data blocks from primary portion P1 of the first storage drive D1. Likewise, mirror portion M2 of third storage drive D2 is configured to store a copy or duplicate of the data blocks from primary portion P2 of the second storage drive D2.

This example illustrates that mirror portions can be offset from the corresponding primary portions of the associated storage drives. For example, although mirror portion M1 of storage drive D2 is located next to or adjacent to primary portion P1 of storage D1, mirror portion M3 of storage drive D1 is not located next to or adjacent to primary portion P3 of storage drive D3. Instead, mirror portion M3 of storage drive D1 is located in an offset manner from primary portion P3 of storage drive D3 such that storage drive D2 is located between storage drive D1 and storage drive D3.

This example also illustrates that the techniques of the present application can be applied to a disk array having more than two storage drives. The storage management module can configure storage primary portions P1, P2, P3 with data stripes that extend across multiple storage drives in a striped array manner such can write data blocks across the primary portions and read data blocks from the primary portions to improve performance. The storage management module 106 can configure storage mirror portions M1, M2, M3 in a mirrored array manner such that if one storage drive fails, the storage management module can copy the data from one of the non-failed drive to a replacement storage drive to allow recovery from the storage drive failure. For example, suppose that storage drive D1 fails, then storage management module 106 can copy mirror portion M1 of storage drive D2 to a primary portion of the replacement drive and copy primary portion P3 of storage drive D3 to the mirror portion of the replacement storage drive. In this manner, the system provides redundancy by providing the ability to rebuild and recover the failed storage drive to replacement storage and allowing the system to resume storage access operations such as read from disk array and write to disk array. In another example, suppose that storage drive D1 fails, then storage management module 106 can read mirror portion M1 of storage drive D2 because it contains a copy of the data of the primary portion of storage drive D1.

FIG. 5B shows an example block diagram of a data storage system 510 in accordance with the techniques of the present application. In one example, to illustrate, system 510 includes a 3-way mirroring disk array comprising first storage drive D1, second storage drive D2, third storage drive D3 and fourth storage drive D4. The storage drives D1 through D4 are configured to have dual mirror portions that are offset in a universal manner. For example, first storage drive D1 is configured to include a primary portion P1 and a first mirror portion M1-4 and a second mirror portion M2-3. The second storage drive D2 is configured to include a primary portion P2 and first mirror portion M1-1 and second mirror portion M2-4. The third storage drive D3 is configured to include a primary portion P3 and first mirror portion M1-2 and second mirror portion M2-1. The fourth storage drive D4 is configured to include a primary portion P4 and first mirror portion M1-3 and second mirror portion M2-2. In one example, the primary portions are configured as striped array and corresponding mirror portions are configured as mirrored array. That is, the primary portions include data stripes extending across the storage drives with each storage drive including strips to store data blocks. The primary portions can be designated as P1 through PN where N represents storage drives, and in this case P1 through P4 where N=4. The storage drives D1 through D4 have dual mirror portions designated as M1-N through M2-N where N represents the number of storage drives, and in this case, for the first mirror portions, M1-1 through M1-4 and, for the second mirror portions, M2-1 through M2-4 where N=4.

A explained above, the dual mirror portions can be configured to store copies of data blocks from primary portions in a universal offset manner. For example, in this case, first mirror portion M1-4 of first storage drive D1 is configured to store a copy or duplicate of the data blocks from primary portion P4 of the fourth storage drive D4, and second mirror portion M2-3 of first storage drive D1 is configured to store a copy or duplicate of the data blocks from primary portion P3 of third storage drive D3. In a similar manner, first mirror portion M1-1 of second storage drive D2 is configured to store a copy or duplicate of the data blocks from primary portion P1 of the first storage drive D1, and second mirror portion M2-4 of second storage D2 is configured to store a copy of the data blocks from primary portion P4 of fourth storage drive D4. In a similar manner, first mirror portion M1-2 of third storage drive D3 is configured to store a copy or duplicate of the data blocks from primary portion P2 of the second storage drive D2, and second mirror portion M2-1 of third storage drive D3 is configured to store a copy or duplicate of the data blocks from primary portion P1 of first storage drive D1. Likewise, first mirror portion M1-3 of fourth storage drive D4 is configured to store a copy or duplicate of the data blocks from primary portion P3 of the third storage drive D3, and second mirror portion M2-2 of fourth storage drive D4 is configured to store a copy or duplicate of the data blocks from primary portion P2 of second storage drive D2.

This example illustrates that mirror portions can be configured in an offset manner from the corresponding primary portions of the associated storage drives. For example, mirror portion M1-4 of storage drive D1 is located in an offset manner from primary portion P4 of storage drive D4 such that storage drives D2 and D3 are located between storage drive D1 and storage drive D4. In addition, this example illustrates that mirror portions can be configured to have more than one portion such as dual portions and the like.

This example also illustrates that the techniques of the present application can be applied to a disk array having more than two storage drives. In this example, the storage management module can configure storage primary portions P1, P2, P3, P4 with data stripes extending across multiple storage drives in a striped array manner such it can write data blocks across the primary portions and read data blocks from across the primary portions to improve performance. In addition, storage management module can configure storage drives to have dual mirror portions in a mirrored array manner such that if one or more storage drives fail, the storage management module can copy the data from one of the non-failed drive to allow recovery from the storage drive failure. For example, suppose that storage drives D1 and D2 fail which renders data from respective primary and mirror portions in accessible. In this case, to restore failed storage drive D1, the storage management module can copy mirror portion M2-1 of storage drive D3 to a primary portion of a first replacement storage drive, copy primary portion P4 of storage drive D4 to the first mirror portion of the replacement storage drive, and copy primary portion P3 of storage drive D3 to the second mirror portion of the first replacement storage drive. In a similar manner, in this case, to restore failed storage drive D2, the storage management module can copy mirror portion M1-2 of storage drive D3 to a primary portion of a second replacement storage drive, copy mirror portion M2-1 of storage drive D3 to the first mirror portion of the replacement storage drive, and copy primary portion P4 of storage drive D4 to the second mirror portion of the second replacement storage drive. In this manner, the system can provide redundancy by providing the ability to rebuild and recover from the failure of two storage drives to replacement storage drives and allowing the system to resume storage operations such as to write to disk array and read from disk array. In another example, in case storage drive D2 fails, storage management module 106 can read duplicate or copy of data from mirror portion M1-2 of storage drive D3 and read data from mirror portion M2-2 of storage drive D4 to allow disk array to continue to operate.

FIG. 5C shows an example block diagram of a data storage system 520 in accordance with the techniques of the present application.

The offset arrangement of storage configuration 520 of FIG. 5C is somewhat similar to the offset arrangement and function of storage configuration 500 of FIG. 5A in that both have mirror portions configured in an offset manner. However, storage configuration 520 of FIG. 5C shows that the offset technique can be applied to one or more groups of storage drives.

In one example, to illustrate, system 520 includes a 2-way disk array comprising four storage drives: first storage drive D1, second storage drive D2, third storage drive D3 and fourth storage drive D4. The storage drives D1 through D4 are configured to have single mirror portions that are offset in a localized manner. For example, first storage drive D1 is configured to include a primary portion P1 and a mirror portion M2. The second storage drive D2 is configured to include a primary portion P2 and a mirror portion M1. The third storage drive D3 is configured to include a primary portion P3 and a mirror portion M4. The fourth storage drive D4 is configured to include a primary portion P4 and a mirror portion M3. In one example, the primary portions are configured as a striped array configuration and corresponding mirror portions are configured as a mirrored array configuration. That is, the primary portions include data stripes extending across the storage drives with each storage drive including strips to store data blocks. The primary portions can be designated as P1 through PN where N represents storage drives, and in this case P1 through P4 where N=4. Likewise, storage drives D1 through D4 have single mirror portions designated as M1 through MN where N represents storage drives, and in this case, M1 through M4 where N=4.

As explained above, the single mirror portions are configured to store copies of data blocks from primary portions in a localized offset manner. For example, to illustrate, storage management module can configure first storage drive D1 and second storage drive D2 as part of first localized offset group 522. Likewise, storage management module 206 can configure third storage drive D3 and fourth storage drive D4 as part of second localized offset group 524. For example, to illustrate, as part of the first localized offset group 522, mirror portion M2 of first storage drive D1 is configured to store a copy or duplicate of the data blocks from primary portion P2 of the second storage drive D2, and mirror portion M1 of second storage drive D2 is configured to store a copy or duplicate of the data blocks from primary portion P1 of the first storage drive D1. In a similar manner, to illustrate, as part of the second localized offset group 524, mirror portion M4 of third storage drive is configured to store a copy or duplicate of the data blocks from primary portion P4 of the fourth storage drive D4, and mirror portion M3 of fourth storage drive D4 is configured to store a copy or duplicate of the data blocks from primary portion P3 of the third storage drive D3.

FIG. 5D shows an example block diagram of a data storage system 530 in accordance with the techniques of the present application. The offset arrangement of storage configuration 530 of FIG. 5D is somewhat similar to the offset arrangement and function of storage configuration 510 of FIG. 5B in that both have dual mirror portions configured in an offset manner. However, storage configuration 530 of FIG. 5D shows that the offset technique can be applied to one or more groups of storage drives.

In one example, to illustrate, system 530 includes a 3-way disk array comprising first storage drive D1, second storage drive D2, third storage drive D3, fourth storage drive D4, fifth storage drive D5, and sixth storage drive D6. The storage drives D1 through D3 are configured to have dual mirror portions that are offset in a localized manner as part of a first localized offset group 532. The storage drives D4 through D6 are configured to have dual mirror portions that are offset in a localized manner as part of a second localized offset group 534. For example, as part of first group 532, first storage drive D1 is configured to include a primary portion P1 and a first mirror portion M1-3 and a second mirror portion M2-2. Likewise, as part of first group 532, second storage drive D2 is configured to include a primary portion P2 and a first mirror portion M1-1 and a second mirror portion M2-3. In a similar manner, as part of first group 532, third storage drive D3 is configured to include a primary portion P3 and a first mirror portion M1-2 and a second mirror portion M2-1. For example, as part of second group 534, fourth storage drive D4 is configured to include a primary portion P4 and a first mirror portion M1-6 and a second mirror portion M2-5. Likewise, as part of second group 534, fifth storage drive D5 is configured to include a primary portion P5 and a first mirror portion M1-4 and a second mirror portion M2-6. In a similar manner, as part of second group 534, sixth storage drive D6 is configured to include a primary portion P6 and a first mirror portion M1-5 and a second mirror portion M2-4.

In one example, the primary portions are configured as a striped array configuration and corresponding mirror portions are configured as a mirrored array configuration. That is, the primary portions include data stripes extending across the storage drives with each storage drive including strips to store data blocks. The primary portions are designated as P1 through PN where N represents storage drives, and in this case P1 through P6 where N=6. The storage drives D1 through D6 have dual mirror portions designated as M1-N through M2-N where N represents storage drives, and in this case, for the first mirror portions, M1-1 through M1-6 and, for the second mirror portions, M2-1 through M2-6 where N=6.

A explained above, the dual mirror portions are configured to store copies of data blocks from primary portions in a localized offset manner. For example, to illustrate, as part of the first localized offset group 532, first mirror portion M1-3 of first storage drive D1 is configured to store a copy of the data blocks from primary portion P3 of the third storage drive D3, and second mirror portion M2-2 of first storage drive D1 is configured to store a copy or duplicate of the data blocks from primary portion P2 of the second storage drive D2. Likewise, as part of the second first offset group 532, first mirror portion M1-1 of second storage drive D2 is configured to store a copy or duplicate of the data blocks from primary portion P1 of the first storage drive D1, and second mirror portion M2-3 of second storage drive D2 is configured to store a copy or duplicate of the data blocks from primary portion P3 of the third storage drive D3. In a similar manner, as part of the first localized offset group 532, first mirror portion M1-2 of third storage drive D3 is configured to store a copy or duplicate of the data blocks from primary portion P2 of the second storage drive D2, and second mirror portion M2-1 of third storage drive D3 is configured to store a copy or duplicate of the data blocks from primary portion P1 of the first storage drive D1.

For example, to illustrate, as part of the second localized offset group 534, first mirror portion M1-6 of fourth storage drive D4 is configured to store a copy or duplicate of the data blocks from primary portion P6 of the sixth storage drive D6, and second mirror portion M2-5 of fourth storage drive D4 is configured to store a copy or duplicate of the data blocks from primary portion P5 of the fifth storage drive D5. Likewise, as part of the second first offset group 534, first mirror portion M1-4 of fifth storage drive D5 is configured to store a copy or duplicate of the data blocks from primary portion P4 of the fourth storage drive D4, and second mirror portion M2-6 of fifth storage drive D5 is configured to store a copy or duplicate of the data blocks from primary portion P6 of the sixth storage drive D6. In a similar manner, as part of the second localized offset group 534, first mirror portion M1-5 of sixth storage drive D6 is configured to store a copy or duplicate of the data blocks from primary portion P5 of the fifth storage drive D5, and second mirror portion M2-4 of sixth storage drive D6 is configured to store a copy or duplicate of the data blocks from primary portion P4 of the fourth storage drive D4.

The techniques of the present application may provide advantages. For example, the techniques of the present application can configure primary portions of storage drives as a striped array configuration disk array with data stripes extending across multiple storage drives in the array. This configuration may cover only 1/m of the intended useful capacities of the disk array. The other mirror set (mirror portions) can be configured in a similar manner with each mirror set arranged in stacking stacked manner to cover the storage drive space. To help preserve the desired data redundancy, the initial storage drive strip of each mirror set (mirror portion) can be offset from each other. In one example, this configuration may provide data redundancy in a similar manner to a combination lock mechanism. That is, each member (storage drive strip) in the top storage disk array (the primary mirror set) may have (m−1) mirrored numbers in other disk arrays (mirror sets). As long as each strip in any array set has corresponding (m−1) mirrored strips in other mirror sets, the desired m-way redundancy may be automatically preserved. There can be several arrangements that can meet the redundancy requirements. In one example, the storage drive count for the storage drive configuration of the present application is no longer restricted or bound by the general rule related to conventional m-way mirror RAID configurations. The only constraint is the total storage drive count must be ≧m in order to achieve the desired m-way redundancy.

In one example, a disk array can be configured as an one-strip offset disk array arrangement. In this case, since the primary and mirror portion set is configured as a RAID-0 (level 0) configuration with stripping across all the storage drives in the disk array, sequential read performance of the proposed m-way mirror RAID configuration may exhibit similar performance to that of a conventional RAID-0 (level 0) configuration with the same storage drive count and can approach aggregated sustained rate of all storage drives in the disk array. Compared to conventional m-way mirror RAID configurations, the sequential read performance of the techniques of the present application can improve to m-times in some cases. In addition to the performance gain for sequential read workloads, the configuration of the present application can provide improvements to random read workloads. Workloads can include the amount and type of I/O requests generated to access disk array. For example, randomly distributed random read workloads may include workloads that may be evenly distributed across all storage drives in the disk array. In addition to the natural load-balance, the primary portion and mirror portion stacked arrangement of the present application may facilitate accessing storage space in each storage drive within the primary mirror set is limited (e.g., 1/m of disk capacity instead of the full disk space).

The techniques of the present application provide a stacking arrangement of the primary portion and mirror portions which may improve read performance. However, not all workloads may benefit from the stacking arrangement. For example, some un-desired latencies may be introduced to the write requests as write requests are served back and forth from the stacking spaces (from all mirror sets) within each storage drive. However, such un-desired latencies can be minimized by buffering write requests first. In one example, the storage controller can include a write-back cache configured to group those requests and schedule write-back one mirror set at a time.

Conventional m-way mirror RAID configurations may require multiple or a plurality of m storage drives to establish m-way mirroring. Instead, the techniques of the present application may provide mirror RAID m-way mirroring in an inline manner. That is, every strip in any mirror set (mirror portion) can automatically have its counterpart in the other (m−1) mirror sets (mirror portions). This inline arrangement may help ensure the exact one-to-(m−1) mirroring arrangement and can help reduce storage drive count restriction. The only constraint is the total storage drive count in the m-way mirror disk array must be larger or equal to m.

In one example, the techniques of the present application can improve read performance, small-to-medium requests in low queues in particular, of HDD based mirror RAID configurations. The write-back cache scheduling process can be performed in such a manner to help increase expected read performance gains which can be achieved at expense of small degradation in write performance.

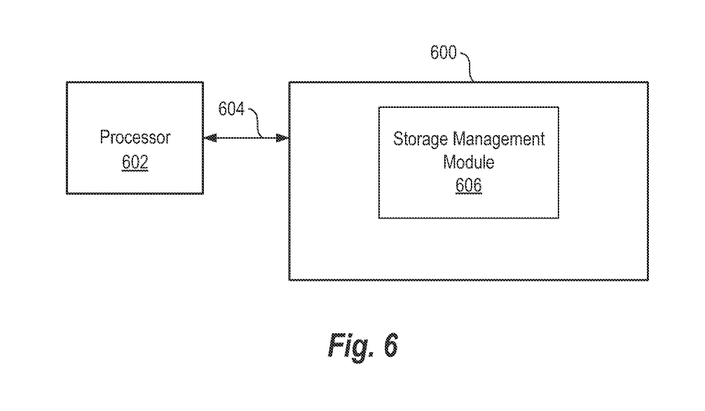

FIG. 6 is an example block diagram showing anon-transitory, computer-readable medium that stores code for operating a data storage system. The non-transitory, computer-readable medium is generally referred to by the reference number 600 and may be included in storage controller 102 described in relation to FIG. 1 or storage controller 202 in relation to FIG. 2. The non-transitory, computer-readable medium 600 may correspond to any typical storage device that stores computer-implemented instructions, such as programming code or the like. For example, the non-transitory, computer-readable medium 600 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 602 generally retrieves and executes the instructions stored in the non-transitory, computer-readable medium 600 to operate a data storage system in accordance an example. In an example, the tangible, machine-readable medium 600 can be accessed by the processor 602 over a bus 604. A first region 606 of the non-transitory, computer-readable medium 600 may include storage management module functionality as described herein.

Although shown as contiguous blocks, the software components can be stored in any order or configuration. For example, if the non-transitory, computer-readable medium 600 is a hard drive, the software components can be stored in non-contiguous, or even overlapping, sectors.

What is claimed is:

1. A data storage system comprising:
a storage controller having a storage management module to:
configure a plurality of storage drives as an m-way mirroring disk array that comprises a primary set with a primary portion on each storage drive member in the array and (m−1) mirror sets with one or more mirror portions on each storage drive member in the array to store duplicated data blocks of the primary set, wherein each of the storage drives to have a primary portion and at least one mirror portion arranged in a stacked configuration,
receive from a host a request to write data blocks to the disk array,
in response to the host request, generate one or more primary write requests to write the data blocks to one or more of the primary portions of the primary set of the plurality of storage drives, and
generate a corresponding one or more mirroring requests to write the duplicated data blocks to one or more corresponding mirror portions of all mirror sets of the plurality of storage drives, wherein, to preserve data redundancy, the primary portion and the corresponding one or more mirror portions with the duplicated data of the primary portion are to reside on different storage drives.

2. The data storage system of claim 1, wherein the storage management module is configured to, in response to receipt of requests to read data blocks, generate read requests to read the data blocks from the primary set or the mirror sets based on load conditions.

3. The data storage system of claim 1, wherein the storage management module is configured to include a cache to buffer one or more write requests before execution of the write requests.

4. The data storage system of claim 1, wherein the storage management module is configured to, in response to a request to read data blocks from the primary portion of a failed storage drive, wherein the storage array to operate in a degraded mode, generate a request to read data blocks from a mirror portion of another storage drive that contain the data blocks of the primary portion of the failed storage drive.

5. The data storage system of claim 1, wherein the storage management module is configured to, in response to an assigned on-line spare storage device or a newly inserted storage drive to replace a failed storage drive, generate requests to copy a mirror portion of another storage drive that contain data blocks of a primary portion of the failed storage drive to the primary portion of a replacement storage drive, and generate one or more requests to copy a primary portion of other storage drives that contain data blocks of one or more mirror portions of the failed storage drive to the corresponding mirror portion of the replacement storage drive.

6. The data storage system of claim 1, wherein the storage management module to configure data stripes of the storage drives to have strips to store consecutively addressed data blocks.

7. The data storage system of claim 1, wherein the storage management module is configured to present the plurality of storage drives as virtual storage drives to a host, and convert virtual storage input/output requests to physical input/out storage requests to access the plurality of storage drives.

8. A method of operating a data storage system comprising:
configuring a plurality of storage drives as an m-way mirroring disk array that comprises a primary set with a primary portion on each storage drive member in the array and (m−1) mirror sets with one or more mirror portions on each storage drive member in the array to store duplicated data blocks of the primary set, wherein each of the storage drives to have a primary portion and at least one mirror portion arranged in a stacked configuration;
receiving from a host a request to write data blocks to the disk array;
in response to the host request, generating one or more primary write requests to write the data blocks to one or more of the primary portions of the primary set of the plurality of storage drives; and
generating a corresponding one or more mirroring requests to write the duplicated data blocks to one or more corresponding mirror portions of the mirror sets of the plurality of storage drives, wherein, to preserve data redundancy, the primary portion and the corresponding one or more mirror portions with the duplicated data of the primary portion are to reside on different storage drives.

9. The method of claim 8, further comprising, in response to receipt of requests to read data blocks, generating read requests to read the data blocks from the primary set or the mirror sets based on load conditions.

10. The method of claim 8, further comprising buffering one or more write requests before execution of the write requests.

11. The method of claim 8, further comprising, in response to a request to read data blocks from the primary portion of a failed storage drive, wherein the storage array to operate in a degraded mode, generating a request to read data blocks from a mirror portion of another storage drive that contain the data blocks of the primary portion of the failed storage drive.

12. The method of claim 8, further comprising, in response to an assigned on-line spare storage device or a newly inserted storage drive replacing a failed storage drive, generating requests to copy a mirror portion of another storage drive that contain data blocks of a primary portion of the failed storage drive to the primary portion of a replacement storage drive, and generating one or more requests to copy a primary portion of other storage drives that contain data blocks of one or more mirror portions of the failed storage drive to the corresponding mirror portion of the replacement storage drive.

13. The method of claim 8, further comprising configuring data stripes of the storage drives to have strips to store consecutively addressed data blocks.

14. The method of claim 8, further comprising presenting the plurality of storage drives as virtual storage drives to a host, and convert virtual storage input/output requests to physical input/out storage requests to access the plurality of storage drives.

15. A non-transitory computer-readable medium having computer executable instructions stored thereon to operate a data storage system, the instruction are executable by a processor to:
configure a plurality of storage drives as an m-way mirroring disk array that comprises a primary set with a primary portion on each storage drive member in the array and (m−1) mirror sets with one or more mirror portions on each storage drive member in the array to store duplicated data blocks of the primary set, wherein each of the storage drives to have a primary portion and at least one mirror portion arranged in a stacked configuration;
receive from a host a request to write data blocks to the disk array;
in response to the host request, generate one or more primary write requests to write the data blocks to one or more of the primary portions of the primary set of the plurality of storage drives; and
generate a corresponding one or more mirroring requests to write the duplicated data blocks to one or more corresponding mirror portions of all mirror sets of the plurality of storage drives, wherein, to preserve data redundancy, the primary portion and the corresponding one or more mirror portions with the duplicated data of the primary portion are to reside on different storage drives.

16. The computer-readable medium of claim 15 further comprising instructions that if executed cause a processor to:
in response to receipt of request to read data blocks, generate a read request to read the data blocks from at least one stripe of a primary portion of storage drives of the plurality of storage drives.

17. The computer-readable medium of claim 15 further comprising instructions that if executed cause a processor to:
buffer one or more write requests before execution of the write requests.

18. The computer-readable medium of claim 15 further comprising tractions that if executed cause a processor to:
in response to a request to read data blocks from the primary portion of a failed storage drive, wherein the storage array to operate in a degraded mode, generate a request to read data blocks from a mirror portion of another storage drive that contain the data blocks of the primary portion of the failed storage drive.

19. The computer-readable medium of claim 15 further comprising instructions that if executed cause a processor to:
in response to an assigned on-line spare storage device or a newly inserted storage drive replacing a failed storage drive, generate requests to copy a mirror portion of another storage drive that contain data blocks of a primary portion of the failed storage drive to the primary portion of a replacement storage drive, and generate one or more requests to copy a primary portion of other storage drives that contain data blocks of one or more mirror portions of the failed storage drive to the corresponding mirror portion of the replacement storage drive.

20. The computer-readable medium of claim 15 further comprising instructions that if executed cause a processor to:
configure data stripes of the storage drives to have strips to store consecutively addressed data blocks.
